(19) United States
(12) Patent Application Publication
(10) Pub. No.: US 2008/0032188 A1
(43) Pub. Date: Feb. 7, 2008

(54) Flat recyclable battery

(76) Inventor: Sueng-Nien Kao, Taipei (TW)

Correspondence Address: Thomas E. Sisson;Jackson Walker, LLP, Suite 2100, 112 E. Pecan, San Antonio, TX, 78205, US

(21) Appl. No.: 11/497,607

(22) Filed: Aug. 2, 2006

(51) Int. Cl. H01M 2/02; H01M 2/36; H01M 2/26

(52) U.S. Cl. 429/162; 429/211; 429/72

(57) ABSTRACT

A flat recyclable battery has a housing, an anode plate, a cathode plate, a sponge and an optional absorbent duct. The housing is flat and has a supply hole. The anode plate is inserted in the housing and has a plate body, an active carbon and an anodic wire. The plate body may be made of or coated with a anodic metal material. The active carbon is applied to the anodic metal material. The anodic wire electrically connects to the anodic metal material. The cathode plate is inserted in the housing and has a plate body and a cathodic wire. The plate body is made of a cathodic metal material. The cathodic wire electrically connects to the cathodic metal material. The sponge is mounted between the anode plate and the cathode plate. The absorbent duct connects the sponge through the housing to an auxiliary water supply.

### BACKGROUND OF THE INVENTION

1. Field of the Invention

The present invention relates to a flat recyclable battery, especially to a flat recyclable battery with a flat housing.

2. Description of the Prior Art

With reference to FIG. 11, a conventional flat recyclable battery is used to supply power and comprises a metal tube (91), a carbon pole (92), an upper plug (93), a sponge (94), a retaining ring (95), a lower plug (96) and an active carbon (98). The metal tube (91) may be made of magnesium, alloy of aluminum and magnesium or zinc, and has an upper opening, a lower opening and an inner surface. The carbon pole (92) has an outer end and a cap (921) capped on the outer end. The cap (921) is made of stainless steel. The upper plug (93) is plugged in the upper opening of the metal tube (91) and has a channel (931) that allows the carbon pole (92) to penetrate through the channel (931). The sponge (94) is set radially inside the metal tube (91) and contains water. The retaining ring (95) is applied coaxially to the inner surface of the metal tube (91) and is used to secure the sponge (94). The lower plug (96) is plugged in the lower opening and has a hole (97) defined through the lower plug (96). The active carbon (98) is stuffed between the upper plug (93) and the sponge (94).

When the conventional flat recyclable battery is used up, the battery is reversed and water is added through the hole (97) to the sponge (94). As the water seeps from the sponge (94) to the active carbon (98), the battery is reactivated and is ready to be used again.

However, the conventional flat recyclable battery sizes too big to be used in a small electronic equipment that employs small flat batteries. To add water, the battery usually has to be disconnected and removed from the electronic equipment, which is inconvenient.

To overcome the shortcomings, the present invention provides a flat recyclable battery to mitigate or obviate the aforementioned problems.

### SUMMARY OF THE INVENTION

The main objective of the invention is to provide a flat recyclable battery that sizes small and is able to receive water without being disconnected from an electronic equipment.

The flat recyclable battery in accordance with the present invention has a housing, an anode plate, a cathode plate, a sponge and an optional absorbent duct.

The housing is flat, receives the anode plate, the cathode plate and the sponge and comprises a supply hole. The supply hole is defined through the housing.

The anode plate is inserted in the housing and has a plate body, an active carbon and an anodic wire. The plate body has an anodic metal material and may be made of the anodic metal material or coated with the anodic metal material. The active carbon is applied to the anodic metal material. The anodic wire electrically connects to the anodic metal material.

The cathode plate is inserted in the housing and has a plate body and a cathodic wire. The plate body has a cathodic metal material and is made of the cathodic metal material. The cathodic wire electrically connects to the cathodic metal material.

The sponge may be made of cotton, contains water, is inserted in the housing and is mounted between the anode plate and the cathode plate.

The absorbent duct connects the sponge through the housing to an auxiliary water supply.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of a flat recyclable battery in accordance with the present invention;

FIG. 2 is a perspective view of the flat recyclable battery in FIG. 1;

FIG. 3 is a side view in partial section of a first embodiment of an anode plate for the flat recyclable battery in FIG. 1;

FIG. 4 is operational top view of the making of the anode plate for the flat recyclable battery in FIG. 3;

FIG. 5 is a side view in partial section of a second embodiment of an anode plate for the flat recyclable battery in FIG. 1;

FIG. 6 is a side view of a cathode plate for the flat recyclable battery in FIG. 1;

FIG. 7 is an operational top view of the flat recyclable battery in FIG. 1 in a small electronic equipment;

FIG. 8 is a cross sectional side view of the flat recyclable battery in FIG. 1 with an absorbent duct;

FIG. 9 is perspective view of the flat recyclable battery in FIG. 8;

FIG. 10 is an operational side view of the flat recyclable battery in FIG. 8 in a small electronic equipment; and

FIG. 11 is a side view in partial section of a conventional flat recyclable battery in accordance with the prior art.

### DETAILED DESCRIPTION OF THE PREFERRED EMBODIMENTS

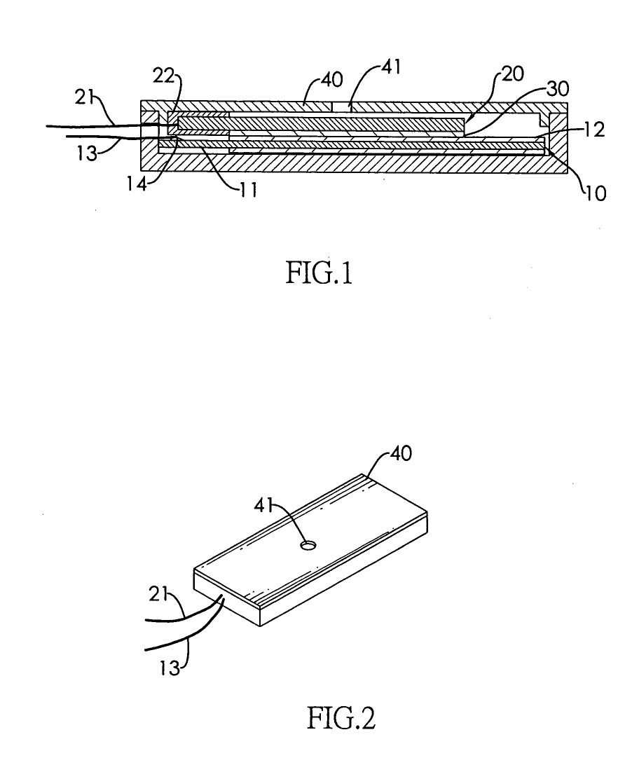

With reference to FIGS. 1 and 2, a first embodiment of the flat recyclable battery in accordance with the present invention comprises a housing (40), an anode plate (10), a cathode plate (20), a sponge (30) and an absorbent duct.

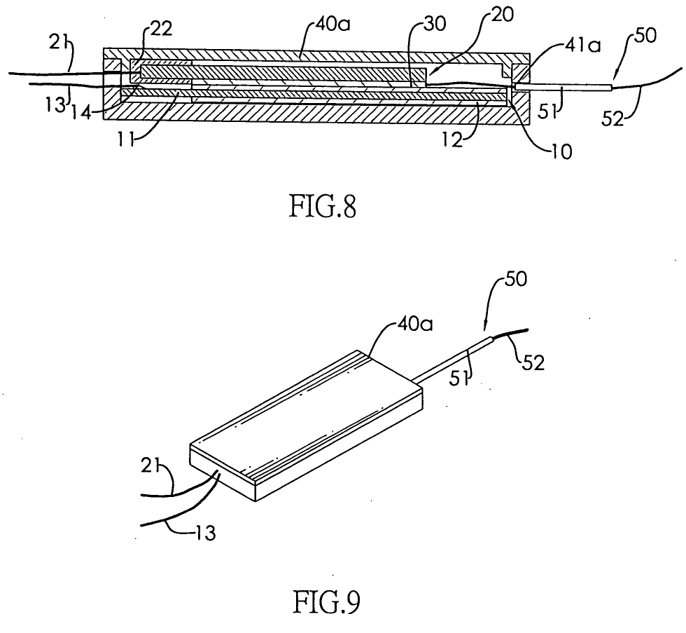

The housing (40) is flat, receives the anode plate (10), the cathode plate (20) and the sponge (30) and comprises at least one supply hole (41), a top surface and a rear end. The at least one supply hole (41) is used for water supply and may be defined through the top surface of the housing (40). With further reference to FIGS. 8 and 9, one of the at least one supply hole (41a) may be defined through the rear end of the housing (40a).

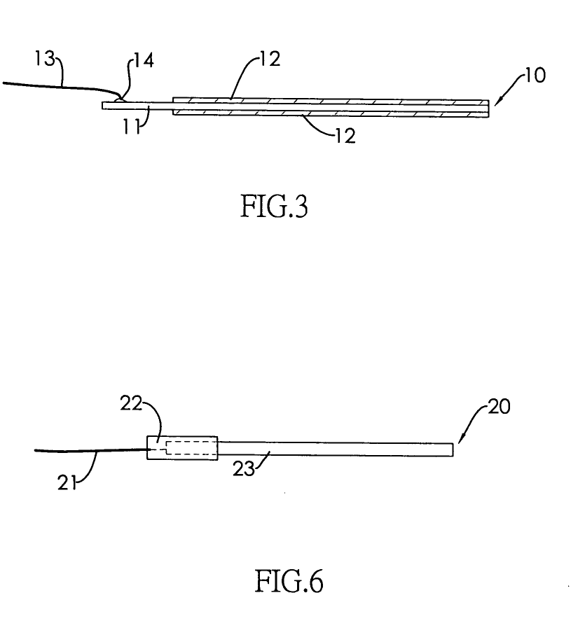

With further reference to FIG. 3, the anode plate (10) is inserted in the housing (40) and has a plate body (11), an active carbon (12) and an anodic wire (13). The plate body (11) has an anodic metal material and may be made of the anodic metal material or coated with the anodic metal material. The anodic metal material may be copper, silver, gold, nickel or an alloy of copper, silver, gold and nickel. The active carbon (12) is applied to the anodic metal material. The anodic wire (13) electrically connects to the anodic metal material and has an interface and an insulation (14). The interface is formed between the anodic wire (13) and the anodic metal material. The insulation (14) covers the interface and may be an insulating gel.

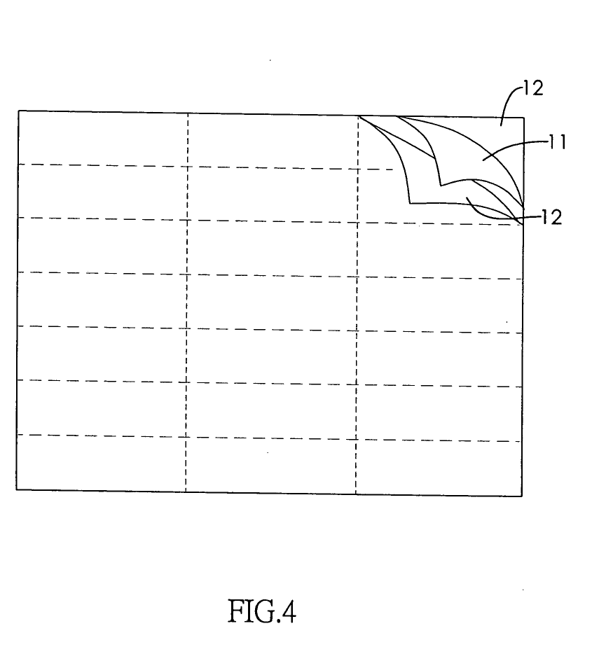

With further reference to FIG. 4, when the anode plate (10) is made, a large plate is made of the anodic metal material and has two surfaces. The active carbon (12) is applied to the two surfaces. The large plate with the active carbon (12) is capable to be divided into multiple anode plates (10).

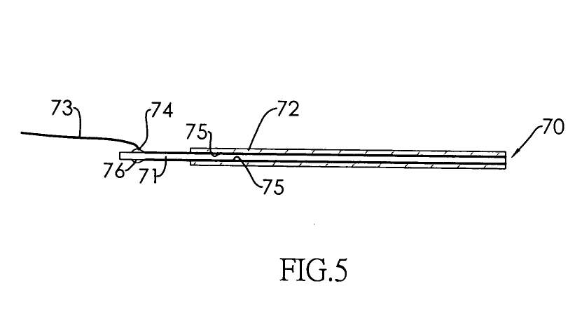

With reference to FIG. 5, an embodiment of the anode plate (70) comprises a plate body (71), an active carbon (72) and an anodic wire (73). The plate body (71) has the anodic metal material, is coated with the anodic metal material (75) and has a connecting hole (76). The connecting hole (76) is defined through the plate body (71) and the anodic metal material (75). The active carbon (72) is applied to the anodic metal material. The anodic wire (73) electrically connects to the anodic metal material (75) by soldering the anodic wire (73) in the connecting hole (76) and has an insulation (74). The insulation (74) covers the connecting hole (76) and may be an insulating gel.

With further reference to FIG. 6, The cathode plate (20) is inserted in the housing (40) has a cathodic metal material, a plate body (23) and a cathodic wire (21). The cathodic metal material may be magnesium, zinc or an alloy of magnesium and zinc. The plate body (23) is made of the cathodic metal material and has a front end. The cathodic wire (21) electrically connects to the cathodic metal material by soldering the cathodic wire (21) to the front end and has an insulation (22). The insulation (22) covers the front end and may be an insulating cap.

The sponge (30) contains water, is inserted in the housing and is mounted between the anode plate (10) and the cathode plate (20) and may be made of cotton.

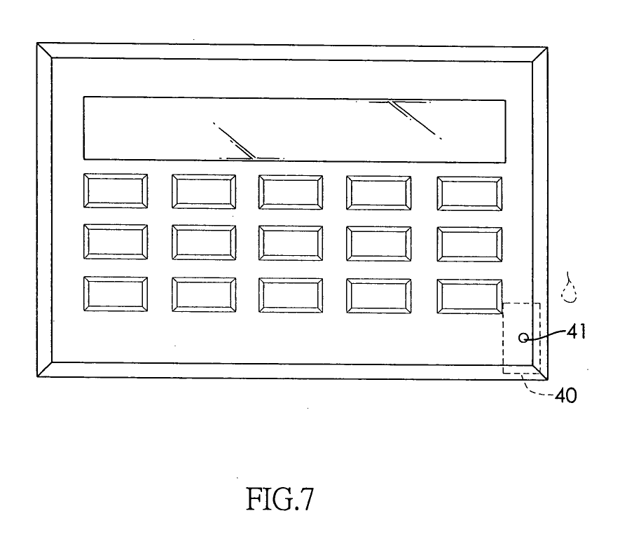

With reference to FIG. 7, the flat recyclable battery in accordance with the present invention may be implemented in a small electronic equipment by the housing (40) being flat. The electronic equipment has a surface. The supply hole (41) of the housing (40) is exposed on the surface. The flat recyclable battery accepts auxiliary water supply through the supply hole (41).

With reference to FIGS. 8 and 9, the absorbent duct (50) comprises a pipe (51) and a thread (52). The pipe (51) extends in the housing (40a) through the supply hole (41a) and has two ends. The thread (52) is longer than and is inserted into the pipe (51) and has two ends. The two ends of the thread (52) protrude respectively from the two ends of the pipe (51). One of the ends of the thread (52) may reaches the sponge (30) and the other accepts auxiliary water supply.

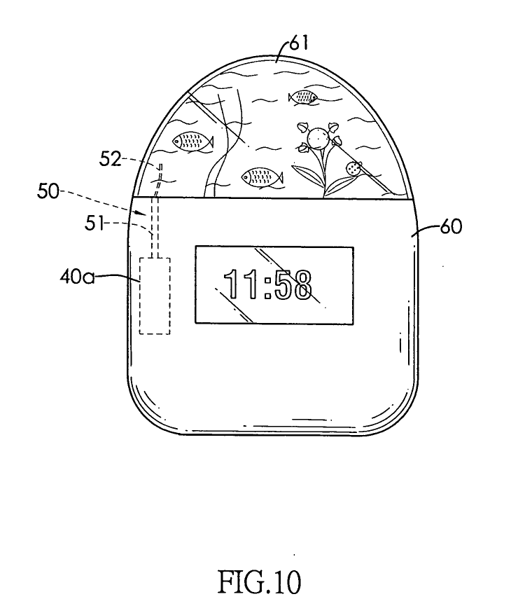

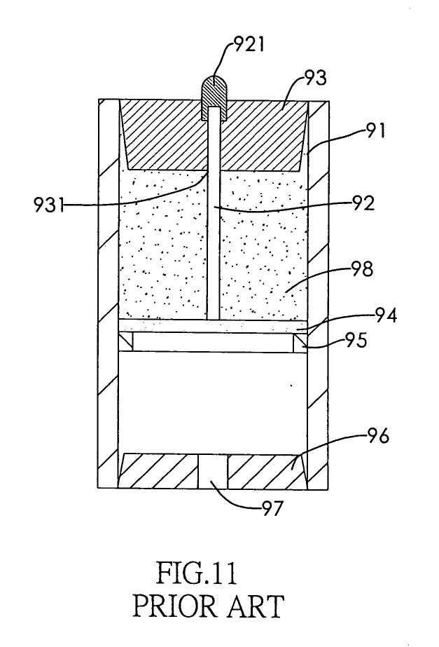

With reference to FIG. 10, the flat recyclable battery in accordance with the present invention may be implemented with the absorbent duct (50) in a small electronic equipment with a water storage unit (61). The electronic equipment has body (60) and a water storage unit (61). The body (60) has an inner space. The water storage unit (61) is a chamber containing water and may contain decorations. The flat recyclable battery is inserted in the inner space of the body (60). The pipe (51) of the absorbent duct (50) connects the battery to the water storage unit (61) and allows the thread (52) to reach the water inside the water storage unit (61). The flat recyclable battery is supplied with water through the absorbent duct (50).

The flat recyclable battery sizes small and is able to receive water without being disconnected from a small electronic equipment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A flat recyclable battery comprising
a housing being flat and having
at least one supply hole being defined through the housing;
an anode plate being inserted in the housing and having
a plate body having
an anodic metal material;
an active carbon being applied to the anodic metal material; and
an anodic wire electrically connecting to the anodic metal material and having
an interface being formed between the anodic wire and the anodic metal material; and
an insulation covering the interface;
a cathode plate being inserted in the housing and having
a cathodic metal material;
a plate body made of the cathodic metal material and having
a front end; and
a cathodic wire electrically connecting to the front end and having
an insulation covering the front end; and
a sponge containing water, being inserted in the housing and being mounted between the anode plate and the cathode plate.

2. The flat recyclable battery as claimed in claim 1, wherein the plate body of the anode plate is made of the anodic metal material.

3. The flat recyclable battery as claimed in claim 1, wherein the plate body of the anode plate is coated with the anodic metal material.

4. The flat recyclable battery as claimed in claim 3, wherein the anode plate further has a connecting hole; the connecting hole is defined through the plate body and the anodic metal material; the anodic wire electrically connects to the anodic metal material by soldering the anodic wire in the connecting hole.

5. The flat recyclable battery as claimed in claim 1, wherein the flat recyclable battery further has an absorbent duct having
a pipe extending in the housing through the at least one supply hole and having
two ends; and
a thread being longer than and inserted into the pipe and having
two ends protruding respectively from the two ends of the pipe.

6. The flat recyclable battery as claimed in claim 1, wherein the anodic metal material is copper, silver, gold, nickel or an alloy of copper, silver, gold and nickel.

7. The flat recyclable battery as claimed in claim 1, wherein the cathodic metal material is magnesium, zinc or an alloy of magnesium and zinc.

8. The flat recyclable battery as claimed in claim 1, wherein the insulation of the anodic wire of the anode plate is an insulating gel.

9. The flat recyclable battery as claimed in claim 1, wherein the insulation of the cathodic wire of the cathode plate is an insulating cap.

10. The flat recyclable battery as claimed in claim 1, wherein the sponge is made of cotton.

11. The flat recyclable battery as claimed in claim 1, wherein the housing has a top surface and one of the at least one supply hole is defined through the top surface.

12. The flat recyclable battery as claimed in claim 1, wherein the housing has a rear end and one of the at least one supply hole is defined through the rear end.
